(19) United States
(12) Patent Application Publication
(10) Pub. No.: US 2013/0203173 A1
(43) Pub. Date: Aug. 8, 2013

(54) Method for determining the concentration of beta-D-glucan

(71) Applicant: Thermo Fisher Scientific Oy, Vantaa (FI)

(72) Inventors: Sari Tikanoja, Vantaa (FI); Annu Suoniemi-Kahara, Vantaa (FI); Liisa Otama, Vantaa (FI)

(73) Assignee: THERMO FISHER SCIENTIFIC OY, Vantaa (FI)

(21) Appl. No.: 13/757,888

(22) Filed: Feb. 4, 2013

(30) Foreign Application Priority Data
Feb. 3, 2012 (FI) 20125119

(51) Int. Cl. G01N 21/75

(52) U.S. Cl. CPC G01N 21/75
USPC 436/43; 436/94

(57) ABSTRACT

Method of selectively determining the concentration of beta-glucan in samples, in particular in liquid samples of cereal origin, and a kit for such analysis. The method comprises the steps of contacting of a beta-glucan containing sample and a dye in liquid phase, complexing the beta-glucan with the dye to provide a modified liquid phase, measuring photometrically the absorbance of the modified liquid phase, and determining the concentration of beta-glucan based on the absorbance of the modified liquid phase. According to the invention, the dye comprises a Calcofluor dye such as Calcofluor White or Calcofluor White M2R. It has been found that the same reagent, or reagent of the kind basic kind, gives the same result when the sample is measured using photometry as when the dye is used in a reaction wherein fluorescence is measured.

### BACKGROUND OF THE INVENTION

1. Field of the Invention

The present invention relates to analysis of liquid samples or samples made to liquid form. More particularly, the present invention concerns a method of determining the concentration of beta-glucan in samples of, for example, cereal origin. The invention also applies to sample of a non-cereal origin, which naturally contain beta-D-glucan or which contain beta-D-glucan added to the sample. The invention further concerns a novel use of Calcofluor dye and a novel kit for determining beta-glucan.

2. Description of Related Art

In the beer brewing process, one of the most important analytes is beta-glucan. Beta-glucan is present in the cell walls of malt and barley, and under certain conditions the beta-glucan released during mashing may be insufficiently hydrolysed. Such beta-glucan is capable of clogging process filters and high levels of beta-glucan give rise to poor wort filtration and beer filtration performance Excessive amounts of beta-glucan may cause haze in the product and even impair the taste of the beer. For this reason it is important to determine the concentration of beta-glucan, in particular the part of the beta-glucan polymer which has a molecular size of about 10,000 Da or more.

The manual on standardized analytical methods in the brewing industry, Analytica-EBC and ASBC, discloses various methods for determining the total mixed linkage (1,3)(1,4)-beta-D-glucan content of malt, extract of malt (congress mash) and hot water extract of malt (constant temperature mash).

The most commonly used routine methods discussed in Analytica-EBC are based on either fluorescence measurement using Calcofluor fluorescence dye either with a flow injection analysis (FIA) apparatus or by carrying out fluorimetry in microplate formate (cf. EBC method 4.16.2). The fluorochrome dye used, Calcofluor, complexes in solution with high molecular weight beta-glucan having a molecular weight of more than 10,000 Da to give an increase in the fluorescence intensity of the dye.

Analytica-EBC also cites a spectrophotometric method of determining beta-glucan which is based on the formation of a beta-glucan-dye complex which absorbs at the wavelength of 550 nm (EBC 4.16.3). (EBC method 4.16.3 is a commercial kit containing dye mixture, Congo red being one or the major component).

There are several drawbacks associated with the known methods.

The Calcofluor method is based on a reaction between a dye and beta-glucan which is highly sensitive to light and oxygen. Fluorimetric methods of the kind disclosed in EBC 8.13.2, 4.16.2 and 3.10.2 have not been applied to discrete analyzers; rather the automatic discrete analyzers are typically based on photometric analysis methods.

On the other hand, the results obtained with the recommended photometric method (Congo red, EBC method collection 4.16.3) do not correlate with the results produced by the Calcofluor method. This obviously reflects the fact that the two methods determine different portions of the beta-glucan polymers. In practice, the dyes used, Calcofluor vs. Congo red, are sensitive to different kinds of molecule fractions. Further, the photometric EBC Congo red method is difficult to use in automatic analyzers because it preferably requires a pretreatment column for differentiating between different molecular sizes. The method is also slow.

In addition to the specific methods identified in the EBC manual, there are mentioned in the art other methods of analyzing beta-glucan concentration.

One alternative spectrophotometric method is based on the use of a Lichinase enzyme, the method comprising measuring and determining glucose obtained from beta-glucan as an enzymatic degradation product. However, this method does not either give results which would be compatible with the fluorimetric Calcofluor method since the enzyme splits up all polymer chains to glucose monomers which means that analysis result will reflect the total concentration of all sizes/polymers of the glucan molecules. Just as the spectrophotometric method of EBC 4.16.3, this method is also difficult to apply to automatic operation because it requires both heating and measurement of the original glucose content of the sample.

In summary, fluorimetric analysis methods described in Analytica-EBC, and commonly used in the brewing industry, require flow injection analysis or microtitre plate readers to give reproducible quantification of fluorescence and, hence, beta-glucan. Manual, photometric methods are based on absorption of beta-glucan molecules having a size of about 2.5×10 ⁵ to the dye CongoRed and/or they require size-dependent filtering before measurement for optimum results.

The results of the fluorimetric and spectrophotometric methods do not correlate with each other for which reason spectrophotometric methods are used to a much lesser extent in the brewing industry.

The brewing industry is, in practice, obliged to follow EBC or ASBC recommendations. Thus, Calcofluor is always used in fluorometric measurement, as even suggested by the trade name Calcofluor, and Fluorescent Brightener 28.

### SUMMARY OF THE INVENTION

It is an aim of the present invention to eliminate at least a part of the above mentioned disadvantages of the art and to provide a method of selectively determining beta-D-glucan in liquid samples.

In particular, it is an aim of the invention to provide an analysis method which is readily applicable to samples, such as liquid samples derived from processing of cereals, such as oat or barley, and which can optionally be performed on automatic analyzers. Such cereal samples may optionally contain beta-D-glucan which has been separately added. The samples may also exhibit depleted contents of beta-D-glucan when compared to the level contents naturally present in the samples as a result of the processing.

It is another aim of the invention to provide an analysis method which is readily applicable samples of non-cereal origin which naturally contain beta-D-glucan or which contain separately added beta-D-glucan, and which can optionally be performed on automatic analyzers.

The present invention is based on the finding that a stilbene-based fluoroscene reagent, Calcofluor, can be used as a dye in a spectrophotometric method of determining beta-D-glucan in liquid samples.

Calcofluor White M2R, which in contrast to the Calcofluor reagent used in fluorometric analysis is colourless, has been used in kinetic photometric analysis of chitosanase for determining the enzyme activity thereof (Somashekat and Josept, 1997). The method described is neither quantitative nor automatic or rapid. Instead the method was used for studying interactions between the dye and the chitosanase enzyme. Absorbance was determined at a wavelength of 406 nm.

The present invention relies on the complex-forming or complexing reaction between the Calcofluor reagent and the large molecular size portion of the glucan polysaccharide polymer.

Surprisingly it has been found that the same reagent, or reagent of the same (Calcofluor) type, gives the same result when the sample is measured using photometry as when the dye is used in a reaction wherein fluorescence is measured.

Based on the above, the present method comprises the steps of contacting of a beta-glucan containing sample and the dye in liquid phase, complexing the beta-glucan with the dye to provide a modified liquid phase, measuring photometrically the absorbance of the modified liquid phase at a main wavelength and optionally a side wavelength, and determining the concentration of beta-glucan based on the absorbance of the modified liquid phase.

Further, the present invention provides for the use of a fluorescent Calcofluor dye in photometric determination of beta-glucan in samples of cereal origin or in samples of non-cereal origin which contain added beta-glucan. Preferably, the samples comprise a liquid phase formed by water or a solvent.

The reagent can be supplied in the form of a photometric kit comprising at least one container containing Calcofluor.

More specifically, the present method is characterized by what is stated in the characterizing part of claim 1.

The use according to the present invention is characterized by what is stated in claim 19.

The kit according to the present invention is characterized by what is stated in claim 21.

Considerable advantages are obtained by the present invention. Thus, the present method gives results which correspond with the results obtained by fluorometry using Calcofluor fluorescence dye as prescribed in EBC 8.13.2, 4.16.2, 3.10.2 and ASBC Wort-18. The invention provides for an automated high throughput quantitative photometric barley beta-glucan analysis using Calcofluor fluorescence dye.

The method can, as already mentioned, be carried out for various kinds of samples, in particular liquid samples, solutions as well as dispersions. It is particularly suitable for determining the beta-D-glucan content of liquid samples of cereal origin.

Examples of samples are samples, in particular, homogeneous samples taken from malt, wort and beer, and generally from any sample obtained from ground grains, such as malt, and mixtures thereof, as such or after fermentation or other chemical or biochemical processing. Further sources of samples include juices of fruits and berries as well as wines in various stages of processing, in particular young wines, and other foodstuff which is derived from organic sources. In one embodiment, the samples are withdrawn from compositions which are obtained when ground grains, such as malt, are soaked in water, preferably warm or hot water of a temperature of 25 to 100° C. and optionally fermented.

In addition to compositions which inherently contain beta-D-glucan, the sample may comprise compositions which also contain added or contaminating beta-D-glucan.

The samples can be in liquid form as such or can be obtained by dissolving or dispersing sample material in water or a solvent.

Calcofluor is not as photosensitive when used (spectro)photometrically as in a fluorometric method, and in the photometrical method there is no need for, e.e., both an excitation and an emissivity filter.

The new reagent is not particularly sensitive to air and it has been shown in the present context that the reagent can be kept in an opened vessel, such as a bottle or container in a photometer, for up to 30 days, without significant decomposition up to 30 days. The activity will remain essentially intact.

Next the invention will be examined more closely with the aid of a detailed description and by referring to the attached drawings.

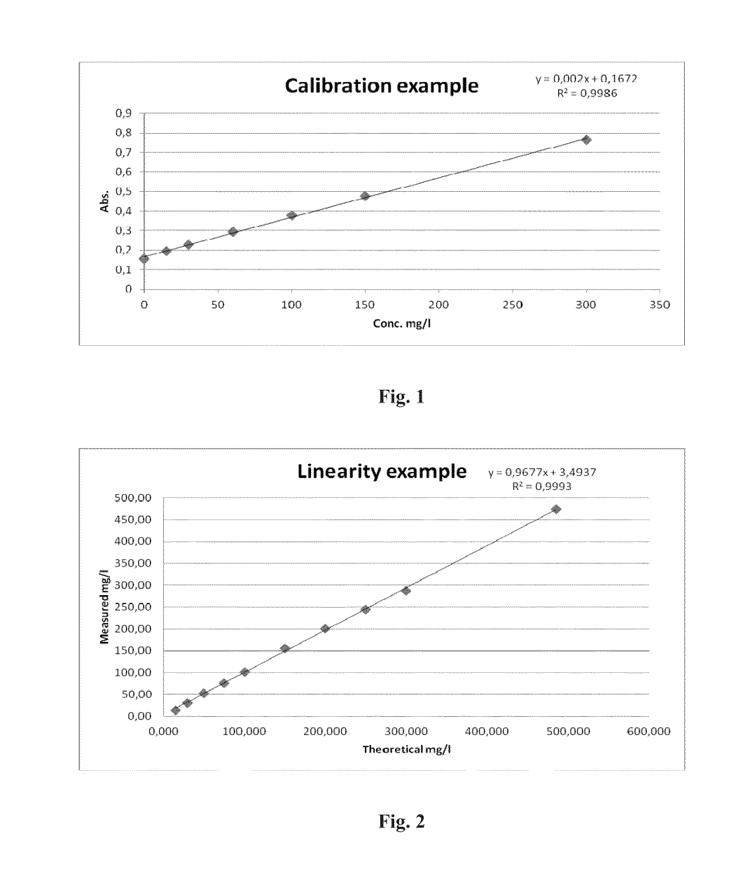

FIG. 1 shows the calibration curve example measured with an automatic photometric analyzer (Gallery) and

FIG. 2 shows a linearity example measured with an automatic photometric analyzer, Gallery.

As briefly discussed above, the present invention provides a novel method of photometrically determining beta-D-glucan in a liquid sample of, for example, cereal origin.

In the following, “beta-D-glucan” and “beta-glucan” are used interchangeably.

A novel reagent composition is provided. The active component of the composition contains, consists of, or consists essentially of, one or several Calcofluor dyes, in particular one or several Calcofluor dyes which exhibit sulphurous groups (e.g. sulpho groups) capable of bonding to hydroxyl groups present in glucan.

In particular, the dye is selected from the group of 4,4′-Bis[4-bis(2-hydroxyethyl)amino]-6-anilino-1,3,5-triazin-2-yl]amino]stilbene-2,2′-disulphonic acid, 5-[[4-(anilino)-6-[bis(2-hydroxyethyl)amino]-1,3,5-triazin-2-yl]amino]-2-[2-[4-[[4-(anilino)-6-[bis(2-hydroxyethyl)amino]-1,3,5-triazin-2-yl]amino]-2-sulfonatophenyl]ethenyl]benzenesulfonate; and 4,4′-bis[6-anilino-[4-[bis(2-hydroxyethyl)amino]-1,3,5-triazin-2-yl]amino]stilbene-2,2′-disulphonate and salts, e.g. sodium salts, thereof. Thus, the three dyes listed in the foregoing can be used as their corresponding disodium salts.

Examples of other Calcofluor dyes include 7-(diethylamino)-4-methylchromen-2-one and 7-(diethylamino)-4-methyl-2H-1-benzopyran-2-one and salts thereof.

Preferably the active component, the dye, is reconstituted at a pH of 9 to 11.

The reagent kit composition typically comprises a liquid composition of the dye in liquid phase which additionally contains a buffering agent, e.g. TritonX-100, to adjust reaction pH.

Other nonionic surfactants, of the TritonX-100 type, which have a hydrophilic polyethylene oxide chain and a preferably aromatic hydrocarbon, lipophilic or hydrophobic group, can be used as well. As can traditional buffers which are useful at the required pH range indicated below. Optionally combinations of the buffers can be employed.

According to a preferred embodiment, the liquid composition contains about 0.01 to 0.1%, e.g. about 0.05% by mass of dye, and 0.01 to 1%, in particular about 0.1% by mass of a buffer, adjusted to a pH in the range of 10±0.5 with a suitable base, such as NaOH.

The dye is supplied e.g. under the trade names of Fluorescent Brighter 28, Calcofluor White M2R, and Tinopal UNPA-GX. The CAS number of the molecule is 4404-43-7 or derivative of Calcofluor based reagent containing e.g Fluorescent Whitening Agents or their salts, such as CAS numbers 4193-55-9 or 95508-20-6.

Of the Calcofluor dyes, the Calcofluor White M2R is particularly preferred since it is colourless. However, also the Calcofluor White dye can readily be used, because the blue colour or tone of it can be blanked out in the analysis.

The reaction between the dye and the beta-D-glucan is carried out at a buffered pH in the range of 7 to 10, in particular 7.5 to 8.5.

In one embodiment, any sample color interference is eliminated by buffer or sample blanking. In practice it has been found that the colour of the sample may disturb the measurement, for example beer contains components which have a photometric absorbance in the measurement range. This interference can, according to the embodiment, be eliminated by using a 2-reagent measurement in which the colour of the sample is eliminated by Blanking. In the measurement a Tris buffer and the sample (an aliquot of, for example, a volume of 10 to 1000 ul, e.g. about 50 to 300 ul), are first subject to a measurement to determine the background absorbance. Then the reagent dye is added and during the progression of the reaction or after completion of the reaction, the next absorbance value determination is carried out. In contrast to the unstable (light and oxidation sensitive) fluorometric method employing Calcofluor, a stable photometric reaction has been obtained.

To eliminate any photosensitivity of the reagent as such, the reagent can be stored in a dark bottle. Once employed in automatic measurement (onboard), the reagent is well protected against light. Thus, the present reagent composition discussed herein is particularly suitable for reliably repeatable photometric determination in an automatic analyser in which several analytes can be dealt with simultaneously.

The blanking in combination with the reliable photometric method will eliminate the poor stability of the original reagent dye.

Based on the above, the method comprises the steps of
contacting the sample and the Calcofluor dye at a buffered pH of 7 to 10;
complexing the beta-glucan with the dye;
measuring photometrically the absorbance of the complex at a wavelength of 380 to 450 nm, for example 405 nm; and
determining the concentration of the complexed portion of the beta-glucan based on the absorbance thus obtained.

With the indicated method, determination of the beta-D-glucan can be carried out from the sample without separate pretreatment thereof.

In a preferred embodiment, in the method the actual measuring step is preferably carried out at a temperature in the range of 0.5 to 50° C., for example at a temperature in the range of 1 to 20° C., or at a temperature which is above room temperature, for instance at a temperature of about 37° C. ±5° C.

In a preferred embodiment, absorbance is measured not only at the indicated wavelength of 405 nm, or more generally 380 to 450 nm, which is considered the main wavelength, but also at a side wavelength of 500 to 800 nm, e.g. 600 nm.

In another preferred embodiment, the method comprising carrying out a quantitative, end-point determination of the beta-glucan. Thus, the reaction is allowed to proceed to completion before initiating absorbance determination. The reaction takes place during an incubation step preceding the end point measurement. The reaction rate is dependent upon temperature and incubation time dependent on the temperature at measurement and volume of the solution.

In another embodiment, the determination is carried out by kinetic measurement, which term designates a procedure wherein absorbance is measured at regular intervals during the propagation of the reaction. Kinetic assays may also be performed in a microtiter plate reader platform. In one embodiment, the kinetic measurement is carried out at a temperature of about 1 to 30° C., for example at about 15 to 25° C. The correct temperature depends on the reaction kinetics. The reaction slows down towards lower temperature enabling kinetic measurement instead of end-point measurement. A suitable temperature can be chosen depending on the instrument specifications. The method as disclosed above can be carried out on an automatic analyzer. If so desired, the sample can be subjected to automated dilution.

Thus, in one embodiment, the method is carried out with a Thermo Fisher Scientific Gallery or Arena analyzer (supplied by Thermo Fisher Scientific Inc.) or another photometric discrete analyzer.

In another embodiment the method is carried out using a flow-injection based instrument, a microtiter plate reader instrument or manually using a conventional type spectrophotometer.

The present method is selective in the respect that it determines selective portions of the beta-D-glucan composition, viz. the large molecular part, typically having a molecular weight of 10,000 Da or more, for example up to 700,000 Da. In this respect the determination will give a fully comparable result with fluorimetric analysis using a different Calcofluor dye.

As discussed above, in one embodiment, the liquid sample is “homogeneous” which term refers to generally any sample, typically any aqueous sample which contains the molecule of interest in a representative aliquot that can be analyzed. In one aspect, the homogeneous sample is clear, or any dispersed phase will not settle out upon standing over a period of at least 30 minutes, preferably at least 2 hours at room temperature.

In another embodiment, determination is carried out for a turbid sample or centrifuged turbid colored samples. Surprisingly it has been found that any background absorption can be removed by blanking of the sample without impairing the reliability of the measurement. The method is particularly useful for routine analysis of samples taken from process stream of a beer making process. The samples are taken from liquid streams containing wort or malt, or generally from any liquid streams obtained from ground grains, such as malt, and mixtures thereof, as such or after fermentation or other chemical or biochemical processing.

The concentration of beta-glucan in the samples is typically on the order of about 0.1 to 10,000 mg/l, in particular about 0.1 to 1500 mg/l, preferably about 0.1 to 500 mg/l. Samples of high original beta-glucan concentration may be diluted to a more suitable concentration area.

The present technology provides a kit for photometrically determining the presence of beta-D-glucan in samples containing said glucan. The kit comprises a) at least one first container having a volume of 1 to 1000 ml containing at least one first component selected from Calcofluor-type dyes, optionally b) at least one second container having a volume of 1 to 1000 ml containing a second component selected from buffer solutions and optionally c) at least one third container having a volume of 1 to 1000 ml comprising a third component selected from standard solutions, e.g. for quality control or calibration purposes, of beta-glucan for covering a concentration range of 1 to 2000 mg/l (cf. below). 1. The kit may additionally comprise washing solutions, sample pretreatment solutions or dilution solutions each in at least one container having a volume of 1 to 1000 ml. Also at least one empty container may be included.

Generally, the containers can have volumes in the ranges of 1 to 20 ml, 1 to 60 ml, 1 to 100 ml, 1 to 200 ml, 1 to 300 ml, 1 to 400 ml, 1 to 500 ml, 1 to 600 ml, 1 to 700 ml, 1 to 800 ml, 1 to 900 ml, or 1 to 1000 ml.

Typical sizes of the container(s) for the first reagent are 20 ml, 50 ml and 60 ml.

The standard solutions mentioned above may cover concentration ranges from 1 to 2000 mg/l, 1 to 1500 mg/l, 1 to 1000 mg/l or 15 to 500 mg/l.

In each kit there are typically 1 to 20 containers, although it is possible to provide for kits comprising even 50 to 150 containers (per box). There is at least 1 container for each reagent or component, typically there are up to 10 containers per reagent (i.e. component). In one embodiment, each of the components may be contained in a set of containers, each set independently comprising 2 to 50 containers.

According to one embodiment, at least one container contains—depending on the container volume—5 to 60 ml of Calcofluor dye. According to a second embodiment, at least one container contains—depending on the container volume—5 to 60 ml of a buffer solution. According to a third embodiment,at least one container contains—depending on the container volume—5 to 60 ml standard solution or solutions of beta-glucan. Combinations of two or three of these embodiments are also possible.

The kit may also contain for example instructions for use, a certificate of analysis or pipetting instructions. The containers may optionally be barcoded.

Next the present technology is illustrated by non-limiting working examples.

In the examples, the blank reagent and the starter reagent had the following compositions:

Blank reagent:

Tris-buffer, pH approx. 8

Starter reagent:

0.05% Fluorescent brightener 28 in 0.1% Triton X-100, adjusted to pH approx 10 with 1M NaOH.

The fluorescent brightener was the disodium salt of 4,4′-Bis[4-bis(2-hydroxyethyl)amino]-6-anilino-1,3,5-triazin-2-yl]amino]stilbene-2,2′-disulphonic acid

### EXAMPLE 1

Application Example for a Discrete Analyzer

The following examples have been carried out on an automatic photometric analyzer, which is supplied by Thermo Fisher Scientific under the name Thermo Scientific Gallery Plus. It is a high capacity bench top system specifically for food, beverage, water and soil testing. Thermo Scientific Gallery Plus is an automated system that allows for laboratory testing of large numbers of samples. The analysis steps are automated.

The discrete cell technology of the Gallery Plus allows for simultaneous measurement of several different tests for the same sample, and eliminates method change-over time. The technology has been adapted to various industrial and environmental applications. Gallery Plus is able to reach very low detection levels, which is particularly important, e.g. to laboratories performing water quality testing. Besides with the colorimetric methods, conductivity and pH can be measured with the optional electrochemical (ECM) unit. Dilutions and re-analysis, when necessary, are handled fully automatically, as is reagent usage monitored in real-time.

The following parametres are suitable for applying the present method on Gallery or a similar type discrete analyzer:
Buffer pH 8, dispensing volume 120 μl (2-120 μl)
Sample, dispensing volume 20 μl (2-120 μl)
Incubation 200 s (0-3600 s)
Blank measurement at 405 nm (380-450 nm), side wavelength 600 nm (500-800 nm)
Starter reagent, dispensing volume 18 μl (2-120 μl)
Incubation 450 s (0-3600 s)
End point measurement at 405 nm, side wavelength 600 nm

Dispensing volumes are sample matrix and concentration dependent. Incubation times depend on dispensing volumes and temperature.

FIG. 1 shows the calibration curve example measured with Gallery. The Calibration curve is application and matrix dependent. Different calibrators, dispensing volumes and incubation times may change the absorbances measured.

FIG. 2 shows a linearity example measured with Gallery. Linearity was performed with water based standard solutions (15-500 mg/l, Barley Beta-Glucan, Sigma-Aldrich). Linearity curve is application and matrix dependent. Different matrices, dispensing volumes and incubation times may change the linearity curve. Linearity range can be extended by changing the automatic dilution parameters or using manual pre-dilution.

TABLE 1
Precision example measured with Gallery

| | wort 1 | | wort 2 | | wort 3 | |
|---|---|---|---|---|---|---|
| | N | 20 | N | 20 | N | 20 |
| | Mean | 195.03 | Mean | 244.74 | Mean | 90.87 |
| | SD | CV % | SD | CV % | SD | CV % |
| Within Run | 0.795 | 0.4% | 1.338 | 0.5% | 0.959 | 1.1% |
| Between Run | 0.166 | 0.1% | 0.549 | 0.2% | 0.129 | 0.1% |
| Total | 0.812 | 0.4% | 1.446 | 0.6% | 0.968 | 1.1% |

Precision was performed with wort samples within two batches with the number of results being 20. Precision is application and matrix dependent. Different matrices, dispensing volumes and incubation times may change the precision obtained.

### EXAMPLE 2

Throughput Example with Gallery Plus
10 requests of photometric beta-glucan assay for 9 samples with the total number of results being 90 (incubation time before blank is 200 s and before end-point measurement is 450 s)
   Total analysis time approx. 40 min
10 requests of photometric beta-glucan assay, 10 requests of SO₂ Total, 10 requests of pH (Colorimetric) and 10 requests of Beer Color for one sample with the total number of results being 40.
   Total analysis time approx. 15 min

### EXAMPLE 3

Application Example for a Manual Spectrophotometer

As discussed above, the method can also be carried out by traditional spectrometry. Thus, in the following exemplifying parametres are listed which are suitable for applying the present method on a manual spectrophotometer which, in this particular case, has a cuvette volume of 2.5 ml:
Buffer pH 8, dispensing volume 20-2500 μl (for example 120 μl)
Sample, dispensing volume 20-2500 μl (for example 20 μl)
Incubation 0-3600 s (for example 200 μl)
Blank measurement at 380-450 nm (for example 405 nm), side wavelength 500-800 nm (for example 600 nm)
Starter reagent, dispensing volume 20-2500 μl (for example 18 μl)
Incubation 0-3600 s (for example 450 s)
End point measurement at 380-450 nm, side wavelength 500-800 nm (for example 405 nm, 600 nm)

Dispensing volumes are sample matrix and concentration dependent. Dispensing volumes must be optimized for the volume of the cuvette used. Incubation times depend on dispensing volumes.

### REFERENCES

Analytica-EBC, Method collection from European Brewery convention (2008).

A new spectrophotometric method of assay for binding chitosanase based on Calcofluor white dye binding (1997). Somashekat and Joseph. Carbohydrate polymers, 34 (1997), 343-346.

Interaction of some dyes with cereal Beta-Glucans (1978). Wood and Fulcher. Cereal Chem 55(6): 952-966).

Megazyme: Beta-Glucan test kit (www.megazyme.com)

ASBC (The American society of brewing chemists) methods of analysis, 2009 edition.

1. Method of selectively determining beta-D-glucan in a sample, comprising the steps of
contacting of the sample and a Calcofluor dye at a buffered pH of 7 to 10;
complexing the beta-glucan with the dye;
measuring photometrically the absorbance of the complex at a wavelength of 380 to 450 nm; and
determining the concentration of the complexed portion of the beta-glucan based on the absorbance thus obtained.

2. The method according to claim 1, wherein the absorbance is measured at a main wavelength of 380 to 450 nm and at a side wavelength of 500 to 800 nm.

3. The method according to claim 1, wherein the dye is reconstituted to a pH in the range of 9 to 11, and reaction is buffered to a pH in the range of 7 to 10.

4. The method according to claim 3, wherein the dye comprises a liquid composition of the dye in liquid phase which additional contains a buffering agent.

5. The method according to claim 1, comprising carrying out a quantitative, end-point determination of the beta-glucan.

6. The method according to claim 1, comprising determining beta-glucan having a molecular weight in excess of 10.000 Da.

7. The method according to claim 1, comprising determining beta-glucan in a sample derived from processing of cereals.

8. The method according to claim 1, comprising determining beta-glucan in a sample selected from the group of liquid samples obtained from ground grains and mixtures thereof, as such or after fermentation or other chemical or biochemical processing.

9. The method according to claim 1, comprising determining beta-glucan in samples withdrawn from compositions which are obtained when ground grains are soaked in water having a temperature of 25 to 100° C.

10. The method according to claim 1, comprising determining beta-glucan in a sample of non-cereal origin which naturally contains beta-glucan or which contains separately added beta-glucan.

11. The method according to claim 10, comprising determining beta-glucan in homogeneous aqueous samples or samples which are dissolved or dispersed in water or in a solvent and which inherently contain beta-glucan or which contain added beta-glucan.

12. The method according to claim 1, comprising carrying out the determination at a temperature in the range of 0.5 to 50° C.

13. The method according to claim 1, wherein any sample color interference is eliminated by buffer or sample blanking

14. The method according to claim 1, wherein determination of the beta-D-glucan is carried out from the sample without separate pretreatment thereof.

15. The method according to claim 1, wherein the concentration of beta-D-glucan in the sample is 0.1 to 10,000 mg/l.

16. The method according to claim 1, wherein the dye is selected from the group of 4,4′-Bis[4-[bis(2-hydroxyethyl)amino]-6-anilino-1,3,5-triazin-2-yl]amino ]stilbene-2,2′-disulphonic acid, 5-[[4-(anilino)-6-[bis(2-hydroxyethyl)amino]-1,3,5-triazin-2-yl]amino]-2-[2-[4-[[4-(anilino)-6-[bis(2-hydroxyethyl)amino]-1,3,5-triazin-2-yl]amino]-2-sulfonatophenyl]ethenyl]benzenesulfonate; and 4,4′-bis[6-anilino-[4-[bis(2-hydroxyethyl)amino]-1,3,5-triazin-2-yl]amino]stilbene-2,2′-disulphonate and salts or from the group of 7-(diethylamino)-4-methylchromen-2-one and 7-(diethylamino)-4-methyl-2H-1-benzopyran-2-one and salts thereof.

17. The method according to claim 1, comprising carrying out the determination on an automatic analyzer.

18. The method according to claim 17, wherein the sample is subjected to automated dilution.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)
